(19) United States
(12) Patent Application Publication
(10) Pub. No.: US 2010/0102281 A1
(43) Pub. Date: Apr. 29, 2010

(54) CONDUCTIVE FILM AND METHOD FOR MANUFACTURING THE SAME, AND ELECTRONIC APPARATUS AND METHOD FOR MANUFACTURING THE SAME

(75) Inventors: Kajiura Hisashi, Tokyo (JP); Enoki Osamu, Tokyo (JP); Yongming Li, Beijing (CN); Jing Zhang, Shanghai (CN); Lian Gao, Shanghai (CN); Jing Sun, Shanghai (CN); Yanqiao Liu, Shanghai (CN); Jiaping Wang, Shanghai (CN)

Correspondence Address: K&L Gates LLP, P. O. BOX 1135, CHICAGO, IL, 60690, US

(73) Assignee: Sony Corporation, Tokyo (JP)

(21) Appl. No.: 12/413,747

(22) Filed: Mar. 30, 2009

(30) Foreign Application Priority Data
Apr. 1, 2008 (CN) 2008-10089140.5

(51) Int. Cl. H01B 1/24; B27N 3/02

(52) U.S. Cl. 252/511; 264/109; 977/742

(57) ABSTRACT

A method for manufacturing a conductive film composed of carbon nanotubes includes the steps of dispersing carbon nanotubes in a solution in which a perfluorosulfonate polymer is dissolved as a dispersant in a solvent; and filtering the solution in which the carbon nanotubes are dispersed.

### CROSS REFERENCES TO RELATED APPLICATIONS

The present application claims priority to Chinese Priority Patent Application CN 2008-10089140.5 filed in the Chinese Patent Office on Apr. 1, 2008, the entire contents of which is incorporated herein by reference.

### BACKGROUND

The present application relates to a conductive film and a method for manufacturing the conductive film, and an electronic apparatus and a method for manufacturing the electronic apparatus. The present application is suitably applied to, for example, various electronic apparatuses in which a flexible transparent conductive film composed of single-walled carbon nanotubes is used.

In recent years, single-walled carbon nanotubes have been widely used to manufacture a flexible transparent conductive film for the purpose of application to electronic apparatuses (refer to Z. Wu, Z. H. Chen, X. Du, J. M. Logan, J. Sippel, M. Nikolou, et al. Transparent conductive carbon nanotube films, Science, 2004, 305, 1273 (Non-Patent Document 1); G. Gruner, Carbon nanotube films for transparent and plastic electronics, Journal of Materials Chemistry, 2006, 16, 3533 (Non-Patent Document 2); Y. X. Zhou, L. B. Hu, and G. Gruner, A method of printing carbon nanotube thin films, Applied Physics Letters, 2006, 88, 123109 (Non-Patent Document 3); E. Artukovic, M. Kaempgen, D. S. Hecht, S. Roth, and G. Gruner, Transparent and flexible carbon nanotube transistors, Nano Letters. 2005, 5, 757 (Non-Patent Document 4); and M. A. Meitl, Y. X. Zhou, A. Gaur, S. Jeon, M. L. Usrey, and J. A. Rogers, Solution casting and transfer printing single-walled carbon nanotube films, Nano Letters. 2004, 4, 1643 (Non-Patent Document 5)). Examples of the method for manufacturing a transparent conductive film composed of single-walled carbon nanotubes include solvent casting (refer to T. V. Sreekumar, T. Liu, S. Kumar, L. M. Ericson, R. H. Hauge, R. E. Smalley, Single-Wall Carbon Nanotube Films, Chemistry of Materials, 2003, 15, 175 (Non-Patent Document 6)), spin coating (refer to Non-Patent Document 5), air brushing (refer to Non-Patent Document 1), dip casting (refer to M. E. Spotnitz, D. Ryan, H. A. Stone, Dip coating for the alignment of carbon nanotubes on curved surfaces, Journal of Materials Chemistry, 2004, 14, 1299 (Non-Patent Document 7)), and a Langmuir-Blodgett technique (refer to Y. Kim, N. Minami, W. H. Zhu, S. Kazaoui, R. Azumi, M. Matsumoto, Langmuir-Blodgett Films of Single-Wall Carbon Nanotubes: Layer-by-layer Deposition and In-plane Orientation of Tubes, Japanese Journal of Applied Physics, 2003, 42, 7629 (Non-Patent Document 8)). However, these methods have limitations due to nonuniformity of formed films, low production efficiency of films, poor controllability of film thickness, aggregation caused by van der Waals interaction between nanotubes (refer to L. Hu, D. S. Hecht, G. Gruner, Percolation in transparent and conducting carbon nanotube networks, Nano Letters. 2004, 4, 2513 (Non-Patent Document 9)), etc. Unlike these methods, a vacuum filtration method (refer to Non-Patent Document 1) developed by Wu, et al. is a simple and efficient method, which can achieve manufacturing of uniform films with various thickness.

Before a transparent conductive film is manufactured by a filtration method, it is necessary to separate single-walled carbon nanotubes and well-disperse them in liquid. Various methods for stably dispersing separated single-walled carbon nanotubes have been developed to date. In the various methods, a surfactant such as sodium dodecyl sulfate (SDS) is widely used to disperse single-walled carbon nanotubes. This is because surfactants give a noncovalent functional group to single-walled carbon nanotubes, which causes almost no damage to the structure of the single-walled carbon nanotubes. It is reported that after such a surfactant is used to disperse single-walled carbon nanotubes, a single-walled carbon nanotube film is manufactured (refer to Non-Patent Document 4 and B. B. Parekh, G. Fanchini, G. Eda, and M. Chhowalla, Improved conductivity of transparent single-wall carbon nanotube thin films via stable postdeposition functionalization, Applied Physics Letters, 2007, 90, 121913 (Non-Patent Document 10)). The surfactant is expected to be removed by cleaning with water in a filtration step. However, a residual surfactant remains so as to coat the single-walled carbon nanotubes, which increases contact resistance between single-walled carbon nanotubes because surfactants are insulators. Thus, various post-treatment processes such as an acid treatment (refer to H. Z. Geng, K. K. Kim, K. P. So, Y. S. Lee, Y. Chan, Y. H. Lee, Effect of acid treatment on carbon nanotube-based flexible transparent conducting films, Journal of the American Chemical Society, 2007, 129, 7758 (Non-Patent Document 11)) have been used to remove surfactants in a single-walled carbon nanotube film and improve electronic properties of films. However, such post-treatment processes are unsuitable because they are limited in accordance with a substrate to be used and may cause damage to single-walled carbon nanotubes. Wang, et al. reports that Nafion (registered trademark) is useful as a solubilizing agent of single-walled carbon nanotubes in the research in which an electrode surface is reformed using single-walled carbon nanotubes in a current-detection biosensor (refer to J. Wang, M. Musmeh, Y. Lin, Solubilization of carbon nanotubes by Nafion toward the preparation of amperometric biosensor, Journal of the American Chemical Society, 2003, 125, 2408 (Non-Patent Document 12)).

### SUMMARY

It is desirable to improve a method for easily manufacturing a conductive film composed of carbon nanotubes with low resistivity in a high production efficiency and to provide such a conductive film composed of carbon nanotubes with low resistivity.

It is also desirable to improve a method for manufacturing a high-performance electronic apparatus by manufacturing the conductive film composed of carbon nanotubes using the method described above and to provide such a high-performance electronic apparatus.

Carbon nanotubes can be well-dispersed using a perfluorosulfonate polymer as a dispersant that is dissolved in a solvent to disperse carbon nanotubes. The solution in which the carbon nanotubes are well-dispersed is filtered by a filtration method (for example, refer to Non-Patent Document 1) to form a film composed of the carbon nanotubes in which the perfluorosulfonate polymer remains between the carbon nanotubes. From the film, a conductive film with low resistivity can be formed.

According to a first embodiment, there is provided a method for manufacturing a conductive film composed of carbon nanotubes, including the steps of dispersing carbon nanotubes in a solution in which a perfluorosulfonate polymer is dissolved as a dispersant in a solvent; and filtering the solution in which the carbon nanotubes are dispersed. In the method for manufacturing a conductive film, contact resistance between the carbon nanotubes is decreased by hot-pressing the obtained conductive film.

According to a second embodiment, there is provided a method for manufacturing an electronic apparatus having a conductive film composed of carbon nanotubes, including a step of forming the conductive film by dispersing carbon nanotubes in a solution in which a perfluorosulfonate polymer is dissolved as a dispersant in a solvent, and filtering the solution in which the carbon nanotubes are dispersed.

In the first and second embodiment, the perfluorosulfonate polymer is a perfluorosulfonate cation-exchange polymer, and the like. For example, Nafion (registered trademark) is commercially available as the perfluorosulfonate cation-exchange polymer. FIG. 1 shows a structure of Nafion. The perfluorosulfonate polymer is conductive.

The conductive film composed of the carbon nanotubes may be transparent or opaque and is selected in accordance with its application.

The perfluorosulfonate polymer remains between carbon nanotubes obtained after filtering a solution in which the perfluorosulfonate polymer is dispersed as a dispersant and carbon nanotubes are dispersed. The amount of the perfluorosulfonate polymer that remains between the carbon nanotubes is not limited as long as electrons move between the adjacent carbon nanotubes through the perfluorosulfonate polymer, resulting in better electrical conduction, and is determined in accordance with the situation. The conductive film may be hot-pressed to further improve electrical conduction. However, when a transparent conductive film is manufactured, the amount of the perfluorosulfonate polymer is limited such that desired transmittance is achieved, because an excessively large amount of perfluorosulfonate polymer that is opaque decreases transparency.

A solution in which a perfluorosulfonate polymer is dispersed as a dispersant and carbon nanotubes are then dispersed is filtered by a filtration method (a similar method described in Z. Wu, Z. H. Chen, X. Du, J. M. Logan, J. Sippel, M. Nikolou, et al. Transparent conductive carbon nanotube films, Science, 2004, 305, 1273) to manufacture a conductive film composed of the carbon nanotubes. Specifically, a solution in which a perfluorosulfonate polymer is dispersed as a dispersant and carbon nanotubes are dispersed is vacuum-filtered using a filtration membrane to form, on the filtration membrane, a film composed of the carbon nanotubes in which the perfluorosulfonate polymer remains between the carbon nanotubes. Thus, the film composed of the carbon nanotubes in which the perfluorosulfonate polymer remains between the carbon nanotubes can be uniformly formed. After the filtration membrane and the film composed of the carbon nanotubes in which the perfluorosulfonate polymer remains between the carbon nanotubes are transferred to a substrate, the filtration membrane is removed. A desired conductive film can be manufactured on a substrate by drying the thus-obtained film composed of the carbon nanotubes in which the perfluorosulfonate polymer remains between the carbon nanotubes. Although the drying method is not limited and selected in accordance with the situation, for example, the film composed of the carbon nanotubes in which the perfluorosulfonate polymer remains between the carbon nanotubes is preferably dried by annealing it in the air at 300° C. Although various substrates can be used and selected in accordance with the situation, a glass substrate or a substrate made of transparent plastic such as polyethylene terephthalate (PET) can be specifically used. The conductive film may be hot-pressed to further improve electrical conduction. The method for hot-pressing is not limited and selected in accordance with the situation. Hot press temperature is also not limited, but hot-pressing is preferably conducted at a temperature higher than or equal to the softening point of the used perfluorosulfonate polymer. Hot press time may be suitably adjusted in accordance with applied pressure.

For example, a solvent composed of water and/or alcohol can be used as the solvent in which the perfluorosulfonate polymer is dissolved. In terms of improvement in dispersiveness of the carbon nanotubes, a solvent containing at least alcohol is preferably used. Any alcohol such as a monohydric alcohol and a polyhydric alcohol or such as a saturated alcohol and an unsaturated alcohol may be basically used. Since a monohydric alcohol including a small number of carbon atoms is liquid at room temperature and mixes with water in any ratio, a solution with high alcohol concentration can be easily prepared. Thus, such a monohydric alcohol is preferred when a mixed solvent of water and alcohol is used. Examples of the alcohol include methanol, ethanol, 1-propanol, 2-propanol (isopropanol), 1-butanol, 2-butanol (sec-butanol), 2-methyl-1-propanol (isobutanol), 2-methyl-2-propanol (tert-butanol), and 1-pentanol. Among these alcohols, ethanol is particularly preferred. The film composed of the carbon nanotubes in which the perfluorosulfonate polymer remains between the carbon nanotubes can be formed on a substrate with good adhesiveness by using a mixed solvent of water and alcohol as the solvent in which the perfluorosulfonate polymer is dissolved. As a result, the conductive film composed of the carbon nanotubes can be formed on a substrate with good adhesiveness.

The carbon nanotubes may be single-walled carbon nanotubes or multi-walled carbon nanotubes. The diameter and length of the carbon nanotubes are also not limited. Although, basically, the carbon nanotubes may be synthesized by any method, examples of the method include laser ablation, electrical arc discharge, and chemical-vapor deposition (CVD).

A conductive or transparent conductive film is applicable to, for example, various electronic apparatuses as a thin film electrode or a transparent electrode. Such a film is applicable to any electronic apparatus as long as a conductive or transparent conductive film is composed of substantially carbon nanotubes, regardless of its application or function. Examples of the electronic apparatuses include field-effect transistors (FET) such as thin film transistors (TFT), molecular sensors, solar cells, photoelectric transducers, light-emitting elements, and memories, but the electronic apparatuses are not limited to these.

According to a third embodiment, there is provided a conductive film composed of carbon nanotubes including a perfluorosulfonate polymer that is present between the carbon nanotubes.

According to a fourth embodiment, there is provided an electronic apparatus having a conductive film composed of carbon nanotubes including perfluorosulfonate polymer that is present between the carbon nanotubes.

The descriptions related to the first and second embodiments apply to the third and fourth embodiments.

In the present application described above, the dispersiveness of carbon nanotubes can be improved by dispersing carbon nanotubes in a solution in which a perfluorosulfonate polymer is dissolved as a dispersant in a solvent composed of, for example, water and/or alcohol. Subsequently, a film composed of the carbon nanotubes in which the perfluorosulfonate polymer remains between the carbon nanotubes can be formed by filtering the solution in which the carbon nanotubes are well-dispersed through a filtration method. Since the perfluorosulfonate polymer is conductive, the electrical conduction between the carbon nanotubes can be improved. This method is simpler than existing methods in which a surfactant is used as a dispersant because there is no step of removing a dispersant.

In the present application according to an embodiment, a conductive film composed of carbon nanotubes with low resistivity can be easily manufactured in a high production efficiency. Various high-performance electronic apparatuses can be achieved using the conductive film.

Additional features and advantages are described herein, and will be apparent from the following Detailed Description and the figures.

### BRIEF DESCRIPTION OF THE FIGURES

FIG. 1 shows a structure of Nafion;

FIGS. 2A to 2C are transmission electron microscopy images respectively showing three supernatants of single-walled carbon nanotubes dispersed in a Nafion-water solution in Example 1;

FIG. 3 is a graph of measurement results showing sheet resistance as a function of transmittance at a wavelength of 550 nm of films formed on a glass substrate by changing the amount of single-walled carbon nanotubes dispersed in a Nafion-water solution in Example 1;

FIG. 4 is a graph of measurement results showing sheet resistance as a function of transmittance at a wavelength of 550 nm of films formed on a PET substrate by changing the amount of single-walled carbon nanotubes dispersed in a Nafion-water solution in Example 1;

FIGS. 5A and 5B are transmission electron microscopy images respectively showing two supernatants of single-walled carbon nanotubes dispersed in a Nafion-ethanol solution in Example 1;

FIG. 6 is a graph of measurement results showing sheet resistance as a function of transmittance at a wavelength of 550 nm of films formed on a glass substrate by changing the amount of single-walled carbon nanotubes dispersed in a Nafion-ethanol solution in Example 1;

FIG. 7 is a graph of measurement results showing sheet resistance as a function of transmittance at a wavelength of 550 nm of films formed on a PET substrate by changing the amount of single-walled carbon nanotubes dispersed in a Nafion-ethanol solution in Example 1;

FIG. 8 is a graph of measurement results showing sheet resistance as a function of transmittance at a wavelength of 550 nm of films formed on a glass substrate, using solutions in which 10 mg of single-walled carbon nanotubes is dispersed in a Nafion-water solution and a Nafion-ethanol solution in Example 1;

FIG. 9 is a graph of measurement results showing sheet resistance as a function of transmittance at a wavelength of 550 nm of films formed on a PET substrate, using solutions in which 10 mg of single-walled carbon nanotubes is dispersed in a Nafion-water solution and a Nafion-ethanol solution in Example 1;

FIG. 10 is a graph of measurement results showing sheet resistance as a function of transmittance at a wavelength of 550 nm of films formed on a glass substrate, using solutions in which 5 mg of single-walled carbon nanotubes is dispersed in a Nafion-water solution and a Nafion-ethanol solution in Example 1;

FIG. 11 is a graph of measurement results showing sheet resistance as a function of transmittance at a wavelength of 550 nm of films formed on a PET substrate, using solutions in which 5 mg of single-walled carbon nanotubes is dispersed in a Nafion-water solution and a Nafion-ethanol solution in Example 1;

FIG. 12 is a graph showing XPS measurement results of transparent conductive films formed with 10 mg of single-walled carbon nanotubes dispersed in a Nafion-water solution and a Nafion-ethanol solution in Example 1;

FIGS. 13A to 13C are transmission electron microscopy images respectively showing three supernatants of 10 mg of single-walled carbon nanotubes dispersed in Nafion-water/ethanol solutions in Example 2;

FIG. 14 is a graph of measurement results showing sheet resistance as a function of transmittance at a wavelength of 550 nm of films formed on a glass substrate, using solutions in which 10 mg of single-walled carbon nanotubes is dispersed in Nafion-water/ethanol solutions with three compositions of water and ethanol in Example 2;

FIG. 15 is a graph of measurement results showing sheet resistance as a function of transmittance at a wavelength of 550 nm of films formed on a PET substrate, using solutions in which 10 mg of single-walled carbon nanotubes is dispersed in Nafion-water/ethanol solutions with three compositions of water and ethanol in Example 2;

FIG. 16 illustrates a comparison of measurement results of sheet resistance as a function of transmittance at a wavelength of 550 nm of films formed on a glass substrate, using solutions in which 10 mg of single-walled carbon nanotubes is dispersed in Nafion-water/ethanol solutions with three compositions of water and ethanol in Example 2, with the measurement results obtained for the films formed in Example 1;

FIG. 17 illustrates a comparison of measurement results of sheet resistance as a function of transmittance at a wavelength of 550 nm of films formed on a PET substrate, using solutions in which 10 mg of single-walled carbon nanotubes is dispersed in Nafion-water/ethanol solutions with three compositions of water and ethanol in Example 2, with the measurement results obtained for the films formed in Example 1; and

FIG. 18 is a graph showing the ratio of sheet resistance (R (T)) of a conductive film formed on a PET substrate after hot-pressing at 10 MPa at 80 to 150° C. for only 1 minute, to sheet resistance (Rᵢₙᵢₜᵢₐₗ) before the hot-pressing as a function of hot press temperature in Example 3.

### DETAILED DESCRIPTION

An embodiment of the present application will now be described with reference to the drawings.

In an embodiment, carbon nanotubes synthesized in advance are dispersed in a solution in which a perfluorosulfonate polymer is dissolved in a solvent composed of water and/or alcohol. The resultant solution is filtered by a filtration method to form, on a filtration membrane, a film composed of the carbon nanotubes in which the perfluorosulfonate polymer remains between the carbon nanotubes. Subsequently, after the filtration membrane and the film composed of the carbon nanotubes in which the perfluorosulfonate polymer remains between the carbon nanotubes are transferred to a substrate, a conductive film composed of the carbon nanotubes is manufactured by removing the filtration membrane and drying the film composed of the carbon nanotubes in which the perfluorosulfonate polymer remains between the carbon nanotubes. Hot pressing may be conducted to improve the electrical conductivity of the conductive film. Although the temperature of the hot pressing is not limited, the hot pressing is preferably conducted at a temperature higher than or equal to the softening point of the used perfluorosulfonate polymer.

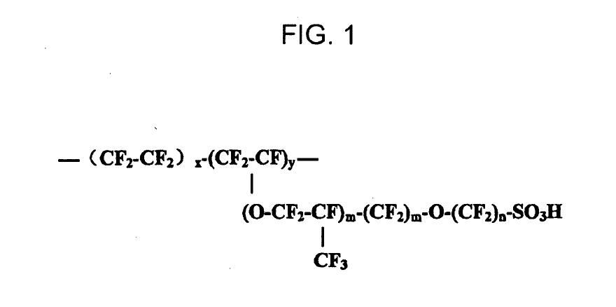

Nafion having a structure shown in FIG. 1 is preferably used as the perfluorosulfonate polymer. In this case, due to a polar side chain included in Nafion, a hydrophobic moiety can interact with carbon nanotubes. As a result of an experiment, the sheet resistance of a Nafion film (a film manufactured by coating 5% by weight of a Nafion solution on a glass or PET substrate and drying it at 150° C.) was of the order of 10⁵ Ω/sq. unlike a surfactant, which is an insulator. This means that when a conductive film composed of carbon nanotubes is manufactured by dispersing carbon nanotubes in Nafion and then by filtering it, the residual Nafion on the carbon nanotubes exhibits lower contact resistance arising between the carbon nanotubes than a surfactant. Thus, post-treatment for removing Nafion is unnecessary.

### EXAMPLE 1

To form transparent conductive films composed of single-walled carbon nanotubes on a glass substrate and a PET substrate, single-walled carbon nanotubes were dispersed in a solution in which Nafion was dissolved in water or ethanol (a solution in which Nafion is dissolved in water is hereinafter referred to as a Nafion-water solution and a solution in which Nafion is dissolved in ethanol is hereinafter referred to as a Nafion-ethanol solution). The resultant solution was filtered by a vacuum filtration method to form transparent conductive films composed of the single-walled carbon nanotubes. The details are as follows.

Single-walled carbon nanotubes available from Chengdu Organic Institute, Chinese Academy of Science, were used. The single-walled carbon nanotubes were synthesized by chemical vapor deposition (CVD) at 1000° C. using methane (CH₄) as a raw material and CoMo as a catalyst. The single-walled carbon nanotubes had a length of about 50 μm and a purity of 90% by weight or more. Nafion was purchased from DuPont. The purchased Nafion having a concentration of 5% by weight was diluted to 0.5% by weight with water. The used water was Millipore water and chemical grade ethanol was used.

To remove impurities (multi-walled carbon nanotubes, amorphous carbon, metallic catalyst, etc.) included in the single-walled carbon nanotubes, 1.7 g of the single-walled carbon nanotubes was oxidized in the air, and then refluxed in 2.6 M of nitric acid (HNO₃) at about 140° C. for 48 hours. The processed single-walled carbon nanotubes were used in the following experiment.

A vacuum filtration method was used to form a transparent conductive film composed of single-walled carbon nanotubes. First, the single-walled carbon nanotubes were dispersed in a Nafion solution through the following processes. Specifically, 5 mg, 10 mg, or 20 mg of the single-walled carbon nanotubes added to 200 ml of a 0.5% by weight Nafion-water solution was dispersed by processing sonication (100 W) with a horn for 2.5 hours. The thus-sonicated solution was centrifuged at 13000 rpm for 30 minutes. The supernatant obtained from the first centrifugation was carefully collected, and again centrifuged at 13000 rpm for 30 minutes. After the supernatant obtained from the second centrifugation was diluted ten times with water, 10 to 150 ml of the resultant solution was used for filtration and formation of a transparent conductive film.

In a manner similar to that in which the single-walled carbon nanotubes were dispersed in a Nafion-water solution, 5 mg or 10 mg of the single-walled carbon nanotubes added to 200 ml of a 0.5% by weight Nafion-ethanol solution was dispersed by processing sonication (100 W) with a horn for 2.5 hours. The sonication was further conducted for 2 hours to obtain single-walled carbon nanotubes uniformly dispersed in the Nafion-ethanol solution. The sonicated solution was centrifuged at 13000 rpm for 30 minutes. The supernatant obtained from the first centrifugation was collected, and again centrifuged at 13000 rpm for 30 minutes. After the supernatant obtained from the second centrifugation was diluted ten times with ethanol, 10 to 150 ml of the resultant solution was used for filtration and formation of a transparent conductive film.

In a filtration step, a Millipore ester membrane with a pore diameter of 200 nm was used as a filtration membrane to make it possible to form single-walled carbon nanotube films having various thickness and density (refer to Non-Patent Document 10). In this step, water or ethanol is not used for cleaning a single-walled carbon nanotube film such that Nafion is not removed by the cleaning. After filtration was conducted and orthodichlorobenzene was dropped to a filtration membrane, the filtration membrane together with a film formed thereon were transferred to a glass or PET substrate. The filtration membrane and the film were dried at 90° C. for 1 hour in the air and then immersed in acetone for 30 minutes to remove the filtration membrane. Thus, a single-walled carbon nanotube film was left on the glass or PET substrate. At the end, the resultant single-walled carbon nanotube film was dried at 150° C. for 1 hour.

Transparent Conductive Film Formed with Single-Walled Carbon Nanotubes Dispersed in Nafion-Water Solution

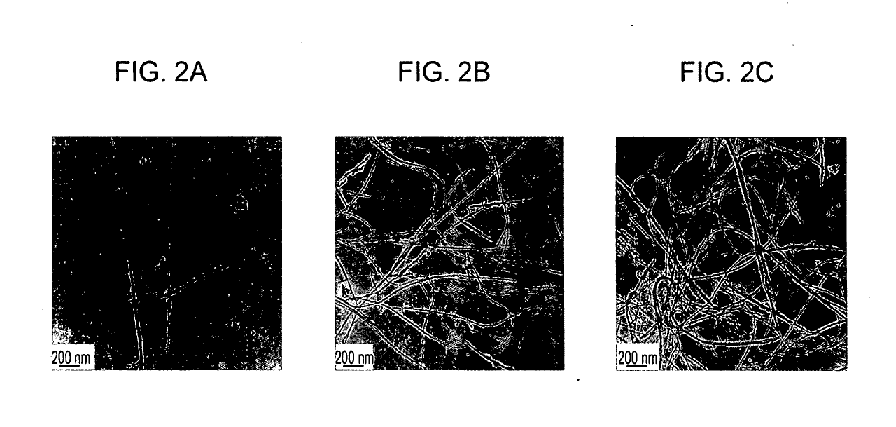

FIGS. 2A, 2B, and 2C are transmission electron microscopy images respectively showing three supernatants, after the two centrifugation processes, of 5 mg, 10 mg, and 20 mg of single-walled carbon nanotubes dispersed in 200 ml of a Nafion-water solution. JEM-2100F (available from JEOL, Tokyo, Japan) was used as a transmission electron microscope. As evident from FIGS. 2A, 2B, and 2C, long single-walled carbon nanotubes were dispersed in the Nafion-water solution. The size of the bundle of the single-walled carbon nanotubes was several hundred nanometers to several tens of nanometers. Since the resistance between single-walled carbon nanotubes increases as the size of the bundle of the single-walled carbon nanotubes increases (refer to Non-Patent Document 2), such a large bundle may affect the electronic properties of single-walled carbon nanotube films.

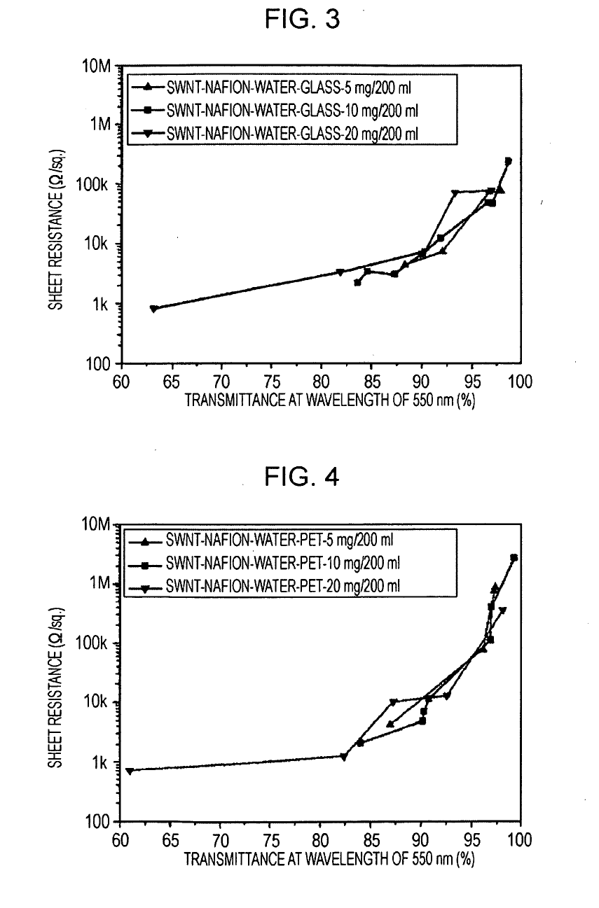

FIG. 3 is a graph of the measurement results showing sheet resistance as a function of transmittance at a wavelength of 550 nm of films formed on a glass substrate by changing the amount of single-walled carbon nanotubes (SWNTs) dispersed in a Nafion-water solution. FIG. 4 is a graph of the measurement results showing sheet resistance as a function of transmittance at a wavelength of 550 nm of films formed on a PET substrate by changing the amount of single-walled carbon nanotubes dispersed in a Nafion-water solution. The transmittance shown in FIGS. 3 and 4 is transmittance of a single-walled carbon nanotube film without a substrate. The transmittance was measured using a UV-Vis spectrometer (Lambda 950 available from Perkin Elmer Inc., Shelton, USA). The sheet resistance was measured using a four-probe resistivity meter (Loresta EP MCP-T360 available from Mitsubishi Chemical, Japan). As clear from FIGS. 3 and 4, a sheet resistance of 3 kΩ/sq. corresponded to about 85% of transmittance. Although the amount of single-walled carbon nanotubes dispersed in a Nafion-water solution was changed from 5 mg/200 ml to 20 mg/200 ml, it seems that there is no significant difference in characteristics between the obtained single-walled carbon nanotube films. This may be because the solubility of single-walled carbon nanotubes in a Nafion-water solution is limited. The amount of single-walled carbon nanotubes increases after the centrifugation, but the amounts of single-walled carbon nanotubes in the supernatants were substantially the same.

Transparent Conductive Film Formed with Single-Walled Carbon Nanotubes Dispersed in Nafion-Ethanol Solution

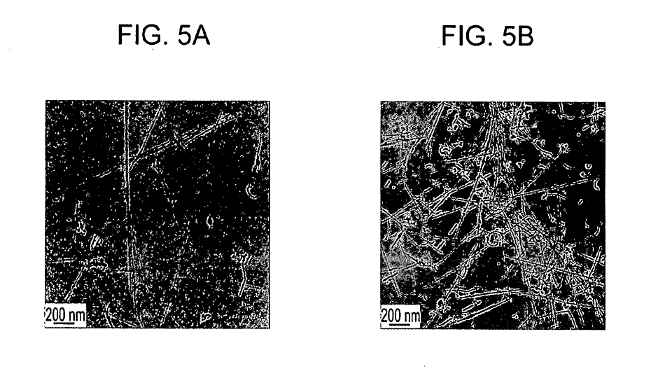

FIGS. 5A and 5B are transmission electron microscopy images respectively showing two supernatants, after the two centrifugation processes, of 5 mg and 10 mg of single-walled carbon nanotubes dispersed in 200 ml of a 0.5% by weight Nafion-ethanol solution. The same transmission electron microscope as above was used. As evident from FIGS. 5A and 5B, some long single-walled carbon nanotubes were dispersed in the Nafion-ethanol solution. The single-walled carbon nanotubes dispersed in the Nafion-ethanol solution had more bundles with a small size than those dispersed in the Nafion-water solution. The size of the smallest bundle of the single-walled carbon nanotubes dispersed in the Nafion-ethanol solution was about 2.5 nm. Since the resistance between single-walled carbon nanotubes decreases as the size of the bundle of the single-walled carbon nanotubes becomes smaller (refer to Non-Patent Document 2), such a small bundle of the single-walled carbon nanotubes improves the electronic properties of single-walled carbon nanotube films.

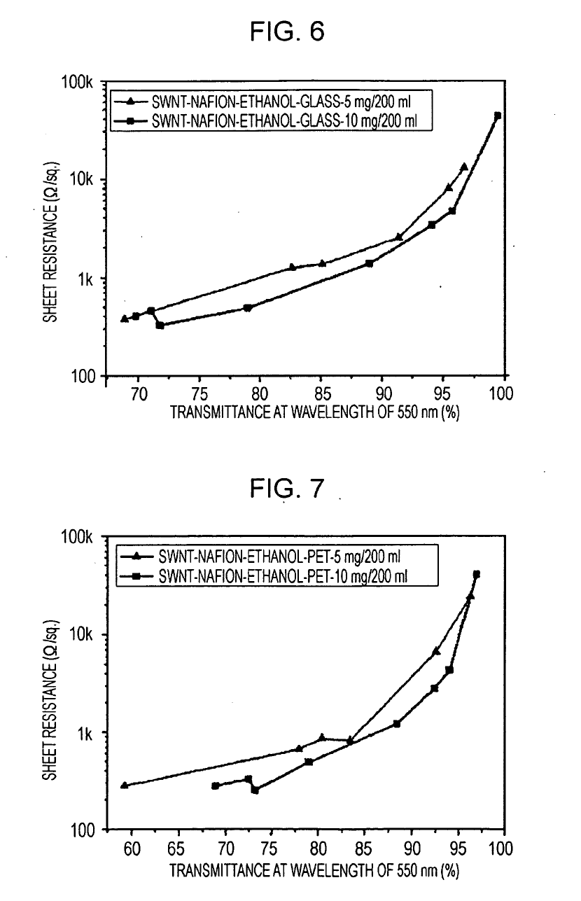

FIG. 6 is a graph of the measurement results showing sheet resistance as a function of transmittance at a wavelength of 550 nm of films formed on a glass substrate by changing the amount of single-walled carbon nanotubes dispersed in a Nafion-ethanol solution. FIG. 7 is a graph of the measurement results showing sheet resistance as a function of transmittance at a wavelength of 550 nm of films formed on a PET substrate by changing the amount of single-walled carbon nanotubes dispersed in a Nafion-ethanol solution. The same measurement devices as above were used for the measurement of transmittance and sheet resistance. As clear from FIGS. 6 and 7, the properties of films were improved as the amount of single-walled carbon nanotubes dispersed in a Nafion ethanol solution was changed from 5 mg/200 ml to 10 mg/200 ml. In the film formed with 10 mg of the single-walled carbon nanotubes dispersed in 200 ml of the Nafion-ethanol solution, about 80% of transmittance was achieved at a sheet resistance of about 500 Ω/sq. This means that the film is a promising candidate that can be replaced with indium-tin oxide (ITO) used as a transparent electrode in the field of organic electronics.

Comparison of Films Formed with Single-Walled Carbon Nanotubes Dispersed in Nafion-Water Solution and Nafion-Ethanol Solution

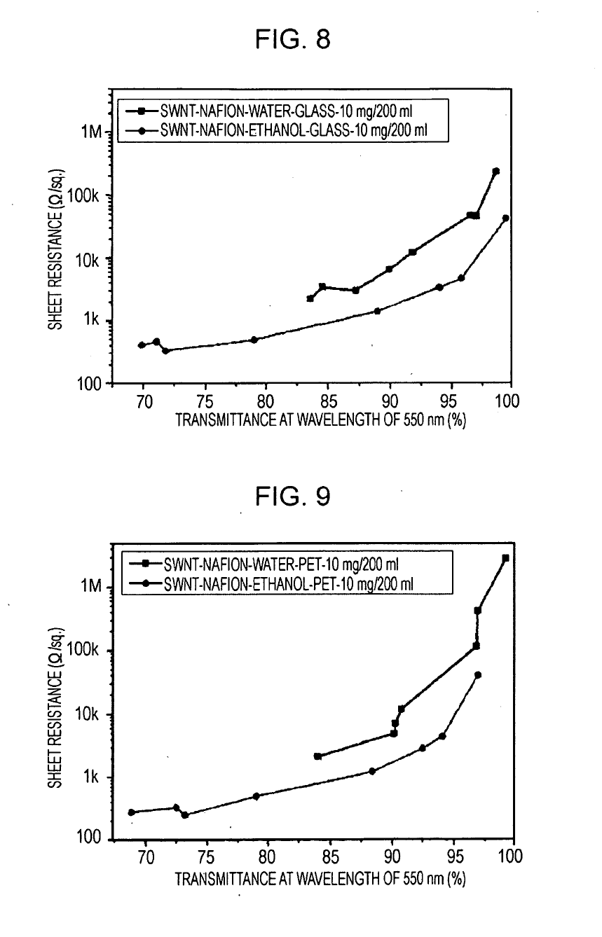

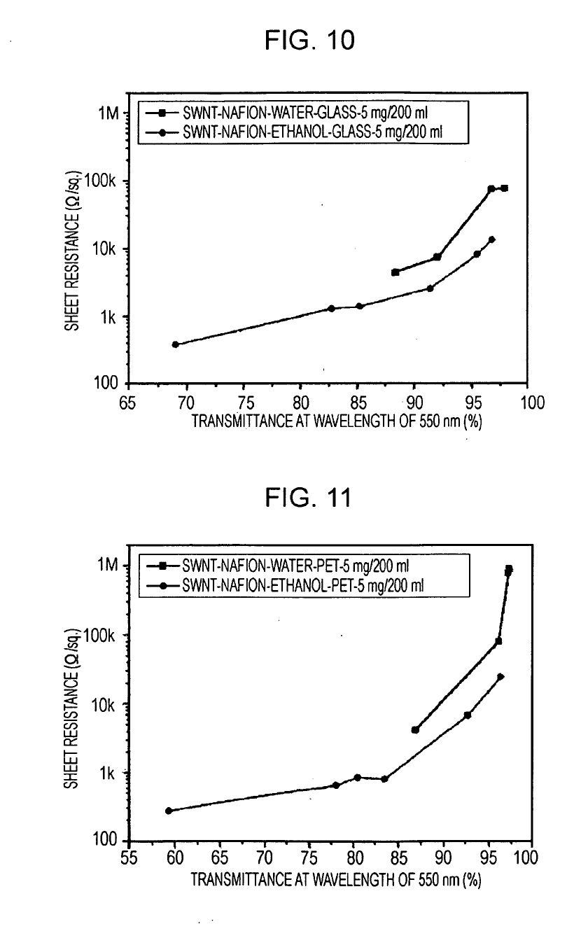

FIGS. 8 to 11 are graphs showing sheet resistance as a function of transmittance at a wavelength of 550 nm of films formed on a glass or PET substrate by changing the amount of single-walled carbon nanotubes dispersed in a Nafion-water solution and a Nafion-ethanol solution. The characteristics of the films formed with the single-walled carbon nanotubes dispersed in a Nafion-ethanol solution were much better than those of the films formed with the single-walled carbon nanotubes dispersed in a Nafion-water solution. At the same transmittance, the sheet resistance decreased three to ten times. Gruner (refer to Non-Patent Document 2) reported that well-dispersed high-quality carbon nanotubes have electrical conductivity higher than those not well-dispersed when both of them have the same transmittance and density. Thus, it can be considered that since the single-walled carbon nanotubes are well-dispersed in the Nafion-ethanol solution, such better characteristics of the single-walled carbon nanotube film can be achieved.

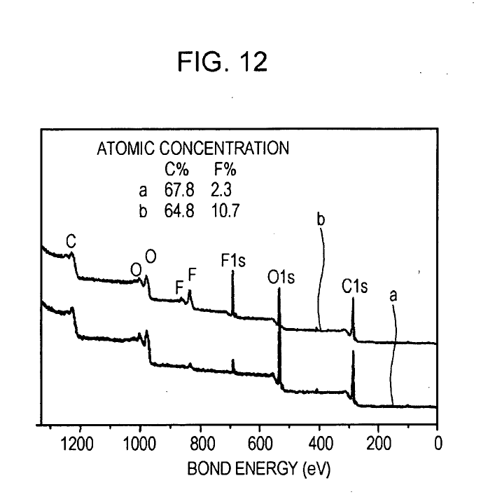

Another reason why the characteristics of films become better is that Nafion positively affects the electrical conductivity of films. FIG. 12 is a graph showing a result of the ultimate analysis of transparent conductive films composed of single-walled carbon nanotubes formed on a PET substrate, which was conducted by X-ray photoelectron spectroscopy (XPS). In FIG. 12, a and b respectively denote measurement results, by XPS, of the transparent conductive films formed with 10 mg of single-walled carbon nanotubes dispersed in 200 ml of a 0.5% by weight Nafion-water and Nafion-ethanol solution. A scanning Auger microprobe having a dual anode (Al/Mg) x-ray source, Microlab 310F, was used for XPS. As evident from FIG. 12, both samples included carbon (C), oxygen (O), fluorine (F), and sulfur (S) from carbon nanotubes and Nafion. Detection of F by XPS means that Nafion is present in a single-walled carbon nanotube film. The film formed with the single-walled carbon nanotubes dispersed in a Nafion-ethanol solution had a higher percentage of F than that formed with the single-walled carbon nanotubes dispersed in a Nafion-water solution, which means the former had a higher percentage of Nafion than the latter. Since the residual Nafion on single-walled carbon nanotubes decreases contact resistance arising between single-walled carbon nanotubes, the film containing more Nafion that is formed with the single-walled carbon nanotubes dispersed in a Nafion-ethanol solution has better electronic properties than the film formed with the single-walled carbon nanotubes dispersed in a Nafion-water solution.

### EXAMPLE 2

To form transparent conductive films composed of single-walled carbon nanotubes on a glass substrate and a PET substrate, single-walled carbon nanotubes were dispersed in a solution in which Nafion was dissolved in a mixed solvent of water and ethanol (this solution is hereinafter referred to as a Nafion-water/ethanol solution). The resultant solution was filtered by a vacuum filtration method to form transparent conductive films composed of the single-walled carbon nanotubes. The details are as follows.

The same single-walled carbon nanotubes, Nafion, water and ethanol for diluting and dissolving Nafion as in Example 1 were used. The same pretreatment (oxidization and reflux treatment) as in Example 1 was conducted before the experiment. A vacuum filtration method was used to form a transparent conductive film composed of single-walled carbon nanotubes. First, the single-walled carbon nanotubes were dispersed in a Nafion solution through the following processes. Specifically, 10 mg of the single-walled carbon nanotubes added to 200 ml of a 0.5% by weight Nafion-water/ethanol solution was sonicated for 2 hours. The sonicated solution was centrifuged at 13000 rpm for 30 minutes. The supernatant obtained from the first centrifugation was collected, and again centrifuged at 13000 rpm for 30 minutes. After the supernatant obtained from the second centrifugation was diluted with water/ethanol solution, filtration and formation of a transparent conductive film were conducted using 10 to 150 ml of the resultant solution. The compositions of water/ethanol solution were 75/25, 50/50, and 25/75. Formation of a single-walled carbon nanotube film by a filtration method was conducted as in Example 1.

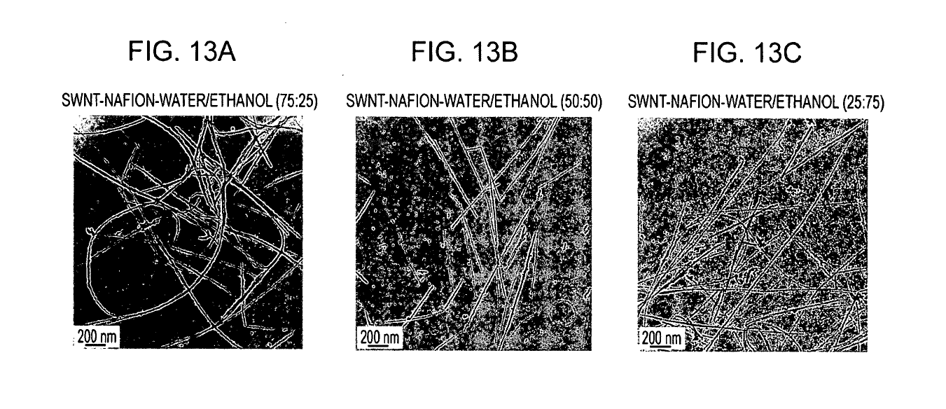

FIGS. 13A, 13B, and 13C are transmission electron microscopy images respectively showing three supernatants, after the two centrifugation processes, of 10 mg of single-walled carbon nanotubes dispersed in 200 ml of a 0.5% by weight Nafion-water/ethanol solution. The same transmission electron microscope as in Example 1 was used. As evident from FIGS. 13A, 13B, and 13C, the single-walled carbon nanotubes dispersed in the Nafion-water/ethanol solutions with compositions of 50/50 and 25/75 had more bundles with a small size than those dispersed in the Nafion-water/ethanol solution with a composition of 75/25.

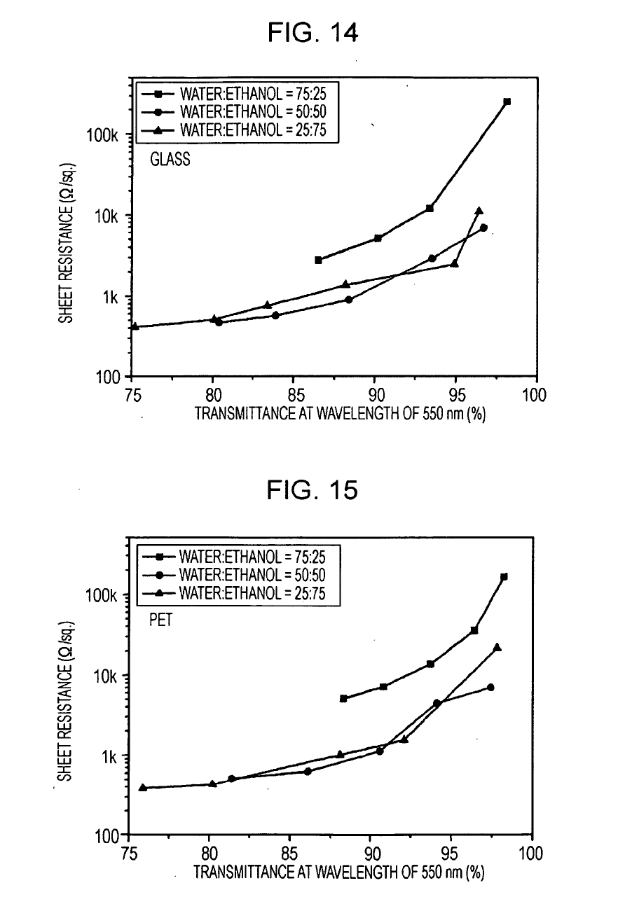

FIG. 14 is a graph of the measurement results showing sheet resistance as a function of transmittance at a wavelength of 550 nm of films formed on a glass substrate, using solutions in which 10 mg of single-walled carbon nanotubes was dispersed in Nafion-water/ethanol solutions with three compositions of 75/25, 50/50, and 25/75. FIG. 15 is a graph of the measurement results showing sheet resistance as a function of transmittance at a wavelength of 550 nm of films formed on a PET substrate, using solutions in which 10 mg of single-walled carbon nanotubes was dispersed in Nafion-water/ethanol solutions with three compositions of 75/25, 50/50, and 25/75. The same measurement devices as in Example 1 were used for the measurement of transmittance and sheet resistance. As evident from FIGS. 14 and 15, the characteristics of the film formed with the single-walled carbon nanotubes dispersed in the Nafion-water/ethanol solution with a composition of 75/25 were worse than those of the films formed with the single-walled carbon nanotubes dispersed in the Nafion-water/ethanol solutions with compositions of 50/50 and 25/75. The characteristics of the film formed with the single-walled carbon nanotubes dispersed in the Nafion-water/ethanol solution with a composition of 50/50 were slightly better than those of the film formed with the single-walled carbon nanotubes dispersed in the Nafion-water/ethanol solution with a composition of 25/75.

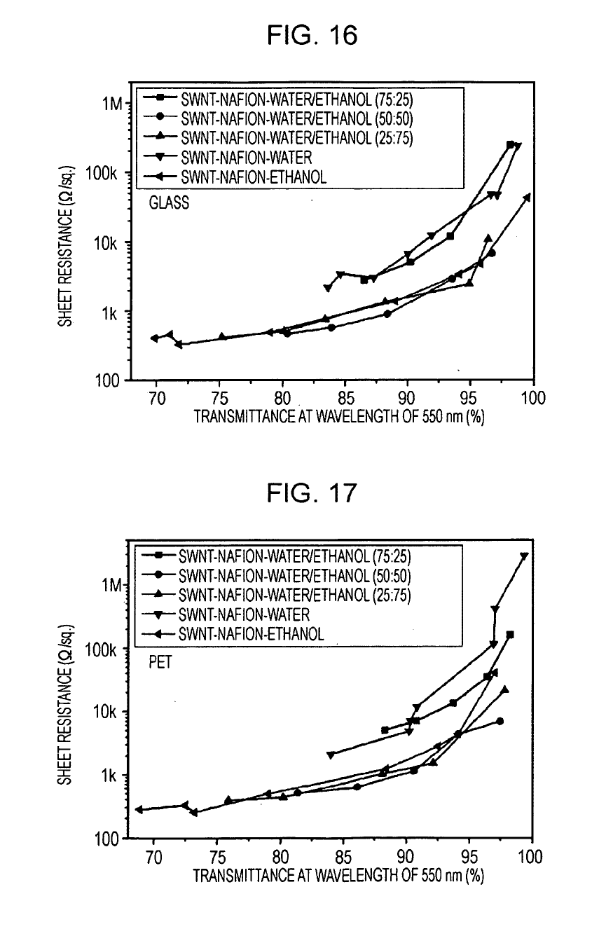

FIG. 16 illustrates a comparison of the measurement results of sheet resistance as a function of transmittance at a wavelength of 550 nm of films formed on a glass substrate, using solutions in which 10 mg of single-walled carbon nanotubes was dispersed in Nafion-water/ethanol solutions with three compositions of 75/25, 50/50, and 25/75, with the measurement results obtained for the films formed in Example 1. FIG. 17 illustrates a comparison of the measurement results showing sheet resistance as a function of transmittance at a wavelength of 550 nm of films formed on a PET substrate, using solutions in which 10 mg of single-walled carbon nanotubes was dispersed in Nafion-water/ethanol solutions with three compositions of 75/25, 50/50, and 25/75, with the measurement results for the films formed in Example 1. As evident from FIGS. 16 and 17, the characteristics of the film formed using a solution in which 10 mg of single-walled carbon nanotubes was dispersed in a Nafion-water/ethanol solution with a composition of 50/50 were the best of all.

Next, the adhesiveness of the films formed on a glass or PET substrate was evaluated. It was found that the adhesiveness of the film formed using a solution in which single-walled carbon nanotubes were dispersed in a Nafion-water/ethanol solution was better than that of the film formed using a solution in which single-walled carbon nanotubes were dispersed in a Nafion-ethanol solution. It was also revealed that the adhesiveness became better as the composition of water relative to ethanol in a Nafion-water/ethanol solution increased. In terms of electronic properties and adhesiveness, the characteristics of the film formed using a solution in which single-walled carbon nanotubes were dispersed in a Nafion-water/ethanol solution with a composition of 50/50 were the best of all.

### EXAMPLE 3

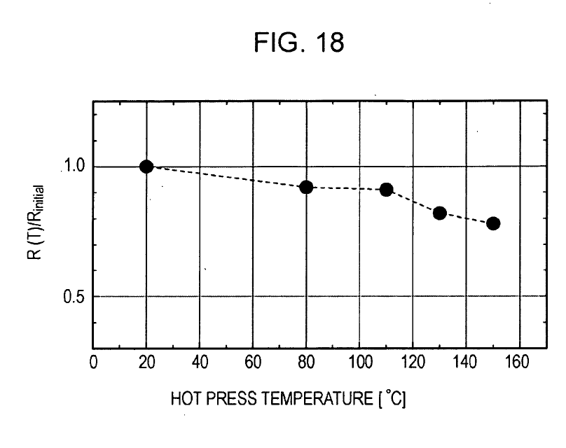

A conductive film formed on a PET substrate was hot-pressed at 10 MPa at 80 to 150° C. for only 1 minute. FIG. 18 is a graph showing the ratio of sheet resistance (R (T)) after hot-pressing to sheet resistance (Rᵢₙᵢₜᵢₐₗ) before the hot-pressing as a function of hot press temperature. The softening point of the used perfluorosulfonate polymer is 120° C. Even below the softening point, sheet resistance can be reduced by about 10% through hot-pressing. When hot-pressing is conducted at a temperature higher than or equal to the softening point, sheet resistance can be reduced by about 20%. Electrical conduction characteristics are significantly improved when hot-pressing is conducted at a temperature higher than or equal to the softening point of the used perfluorosulfonate polymer.

In the embodiment described above, since carbon nanotubes are dispersed in a solution in which a perfluorosulfonate polymer is dissolved in a solvent composed of water and/or alcohol, the carbon nanotubes can be well-dispersed. The resultant solution is filtered by a filtration method to form, on a filtration membrane, a film composed of the carbon nanotubes in which the perfluorosulfonate polymer remains between the carbon nanotubes. Subsequently, after the filtration membrane and the film composed of the carbon nanotubes in which the perfluorosulfonate polymer remains between the carbon nanotubes are transferred to a substrate, the filtration membrane was removed and the film was dried. As a result, a carbon nanotube film with low resistivity or a carbon nanotube film with low resistivity and high transmittance, that is, a good conductive film or a good transparent conductive film composed of carbon nanotubes with low resistivity or with low resistivity and high transmittance can be manufactured. The conductive film or the transparent conductive film is applicable to, for example, thin-film electrodes or transparent electrodes of various electronic apparatuses, which can achieve manufacturing of high-performance electronic apparatuses.

An embodiment and Examples of the present application have been specifically described. However, the present application is not limited to the embodiment and Examples described above, and various modification can be made in accordance with the technical aspect of the present application.

For example, the numerical values, raw materials, processes, and the like mentioned in the embodiment and Examples described above are mere examples. Numerical values, raw materials, processes, etc. different from these may be used as necessary.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for manufacturing a conductive film composed of carbon nanotubes, comprising:
dispersing carbon nanotubes in a solution in which a perfluorosulfonate polymer is dissolved as a dispersant in a solvent; and
filtering the solution in which the carbon nanotubes are dispersed.

2. The method for manufacturing a conductive film according to claim 1, wherein the perfluorosulfonate polymer remains between the carbon nanotubes obtained after filtering the solution in which the carbon nanotubes are dispersed.

3. The method for manufacturing a conductive film according to claim 2, wherein, by vacuum-filtering the solution in which the carbon nanotubes are dispersed using a filtration membrane, a film composed of the carbon nanotubes in which the perfluorosulfonate polymer remains between the carbon nanotubes is formed on the filtration membrane.

4. The method for manufacturing a conductive film according to claim 3, further comprising:
transferring the filtration membrane and the film composed of the carbon nanotubes in which the perfluorosulfonate polymer remains between the carbon nanotubes to a substrate; and
removing the filtration membrane.

5. The method for manufacturing a conductive film according to claim 4, further comprising:
drying the film composed of the carbon nanotubes in which the perfluorosulfonate polymer remains between the carbon nanotubes after the filtration membrane is removed.

6. The method for manufacturing a conductive film according to claim 5, wherein the film composed of the carbon nanotubes in which the perfluorosulfonate polymer remains between the carbon nanotubes is dried by annealing in the air.

7. The method for manufacturing a conductive film according to claim 5, wherein the film composed of the carbon nanotubes in which the perfluorosulfonate polymer remains between the carbon nanotubes is dried by annealing in the air at 300° C.

8. The method for manufacturing a conductive film according to claim 1, wherein the solvent is composed of water and/or an alcohol.

9. The method for manufacturing a conductive film according to claim 8, wherein the alcohol is ethanol.

10. The method for manufacturing a conductive film according to claim 1, wherein the carbon nanotubes are single-walled carbon nanotubes or multi-walled carbon nanotubes.

11. The method for manufacturing a conductive film according to claim 1, wherein the conductive film is a transparent conductive film

12. The method for manufacturing a conductive film according to claim 1, wherein contact resistance between the carbon nanotubes is decreased by hot-pressing the obtained conductive film to improve electrical conduction characteristics of the conductive film.

13. A method for manufacturing an electronic apparatus having a conductive film composed of carbon nanotubes, comprising:
forming the conductive film by dispersing carbon nanotubes in a solution in which a perfluorosulfonate polymer is dissolved as a dispersant in a solvent, and filtering the solution in which the carbon nanotubes are dispersed.

14. The method for manufacturing an electronic apparatus according to claim 13, wherein the perfluorosulfonate polymer remains between the carbon nanotubes obtained after filtering the solution in which the carbon nanotubes are dispersed.

15. A conductive film composed of carbon nanotubes, comprising:
a perfluorosulfonate polymer that is present between the carbon nanotubes.

16. An electronic apparatus comprising:
a conductive film composed of carbon nanotubes, the conductive film including a perfluorosulfonate polymer that is present between the carbon nanotubes.
